(19) United States
(12) Patent Application Publication
(10) Pub. No.: US 2024/0117959 A1
(43) Pub. Date: Apr. 11, 2024

(54) EMERGENCY LIGHTING SYSTEM

(71) Applicant: E2 Lighting International Inc., Grapevine, TX (US)

(72) Inventor: Michael Kwong, Southlake, TX (US)

(21) Appl. No.: 17/962,195

(22) Filed: Oct. 7, 2022

(51) Int. Cl. F21V 23/04; F21S 9/02

(52) U.S. Cl. CPC F21V 23/0457; F21S 9/022

(57) ABSTRACT

An emergency lighting fixture including a light housing having reflective surfaces for providing light in a generally downward direction, the housing mountable to a ceiling surface having low clearance. The emergency lighting fixture includes an LED lamp disposed in the light housing, a control box movable with respect to the light housing, a battery and a control circuit for controlling power flow through the battery and the power flow through the LED lamp. The emergency lighting fixture includes a wire harness electrically connecting the LED lamp through the light housing to the control box, an LED indicator and a test button disposed on the bottom surface of the light housing. When power is supplied to the LED lamp from the control circuit an area is illuminated below the emergency lighting fixture.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates, in general, to the field of lighting, and more specifically, to an emergency lighting fixture.

### Description of Related Art

The emergency lights are commonly used in commercial buildings, hospitals, schools, offices and residential housing. They commonly include a cabinet mounted on a wall or on the bottom surface of a ceiling. The cabinet includes a rechargeable battery and has a light source mounted to the cabinet. The emergency lights serve a useful purpose in having the ability to provide lighting in a power outage, but they are not a welcome addition to a decorated area.

When there is a power outage, current emergency lighting fixture has power to provide lighting for a period of time but do not look aesthetically pleasing, especially given that the lighting fixture and battery are separated and mounted in the interior of a room or space. The current system is complicated for installation and has inconvenient wiring connections. The current set up includes the lighting fixture and the battery pack separated, they need to be rewired before completing an installation set up. This installation process is the most painful process. There is a need for an aesthetically pleasing emergency light which includes a pre-wired battery and lighting fixture for safer and faster installation process.

In particular there is a need for an emergency light fixture which provides lighting and module control and can blend in with a variety of decorative themes.

There is also a need for a slim or low profile down downwardly facing light fixture which provides emergency lighting in a power outage or other event. The light fixture includes a battery as a rechargeable power source for the system.

There is also a need for a slim or low profile down downwardly facing light fixture which combines a compatible battery pack and down light fixture to create an emergency lighting fixture.

There is also a need for a down light fixture and a pre-wired battery with backup capabilities in one metal housing.

There is also a need for a slim or low profile down downwardly facing light fixture which saves on labor costs in reducing additional holes in the ceiling for housing the push button. The push button indicator pre-wired into the fixture, preferably on the surface of the downward facing housing.

There is also a need for a slim or low profile down downwardly facing light fixture which is decoratively appealing.

### BRIEF SUMMARY OF THE INVENTION

The instant invention in one form is directed to an emergency lighting fixture including a light housing having reflective surfaces for providing light in a generally downward direction, the housing mountable to a ceiling surface having low clearance. The emergency lighting fixture includes an LED lamp disposed in the light housing, a control box movable with respect to the light housing, a battery and a control circuit disposed for controlling power flow through the battery and the power flow through the LED lamp. The emergency lighting fixture includes a wire harness electrically connecting the LED lamp through the light housing to the control box, an LED indicator on a bottom surface of the light housing, a cable electrically connecting the control box and the LED lamp in the light housing and a test button disposed on the bottom surface of the light housing. Power is stored in the battery and the battery is in constant electrical connection to the control circuit. When power is supplied to the LED lamp from the control circuit an area is illuminated below the emergency lighting fixture. The LED indicator may be on when the (Emergency Battery Back Up mode) EBBU mode is activated. The LED indicator may flicker slowly when the battery in charging and may flicker quickly when an (Emergency Battery Back Up error) EBBU error occurs. Depressing the test button may activate the EBBU mode while releasing the test button may revert the mode to AC. The emergency lighting fixture may include a dimmer for reducing the power supplied to the LED lamp. The LED lamp may provide at least 1000 lumens. The emergency lighting fixture may be ETL and ES certified. Power into the LED lamp may be between 5 watts and 30 watts and preferably between 10 watts and 18 watts. The LED lamp color may be between 2200K and 6000K and preferably between 2700K and 5000K. The light housing may be constructed of die-cast aluminum. The emergency lighting fixture according to claim 1 wherein the wattage of the LED lamp is tunable.

Another aspect of the present invention is directed to a method for installing an emergency lighting fixture. The method includes providing a light housing having reflective surfaces for providing light in a generally downward direction, the housing mountable to a ceiling surface having low clearance, the emergency lighting system including an LED lamp disposed in the light housing, a control box movable with respect to the light housing, a battery, a control circuit disposed for controlling power flow through the battery and the power flow through the LED lamp, a wire harness electrically connecting the LED lamp through the light housing to the control box, an LED indicator on a bottom surface of the light housing, a cable electrically connecting the control box and the LED lamp in the light housing and a test button disposed on the bottom surface of the light housing wherein power is stored in the battery and the battery is in constant electrical connection to the control circuit and wherein when power is supplied to the LED lamp from the control circuit an area is illuminated below the emergency lighting fixture. The method includes providing an opening in a ceiling where the emergency lighting system is to be installed, wiring a power cable to the emergency lighting system control box, placing the control box in above the ceiling and mounting the light housing in the ceiling opening.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a bottom plan view of the emergency lighting system according to the present invention;

FIG. 2 is a perspective view of the control box shown in FIG. 1;

FIG. 3 is a bottom plan view showing various sizes of the visible portion of the emergency lighting system;

FIG. 4 shows a typical wiring layout for the emergency lighting system;

FIG. 5 shows a method of mounting the emergency lighting system;

FIG. 6 is a bottom plan view of the visible portion of the emergency lighting system;

FIG. 7 shows a perspective view of a second embodiment of emergency lighting system;

FIG. 8 is bottom plan view of the second embodiment of the emergency lighting system shown in FIG. 7;

FIG. 9 shows a side elevational view of the second embodiment of the emergency lighting system according to the present invention;

FIG. 10 is a bottom plan view of the emergency lighting system shown in FIG. 9;

FIG. 11 shows a bottom plan view of another embodiment of the emergency lighting system according to the present invention;

FIG. 12 is a side elevational view of the emergency lighting system shown in FIG. 11; and

FIG. 13 is a perspective view of yet another embodiment of the emergency lighting system according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms exiting emergency down light fixture, emergency light fixture and emergency down light may be used interchangeably to mean an emergency light fixture which illuminates in a generally downward direction. The term “slim” with respect to the housings refers to the relatively small height of any housing wherein the LED lamp is close to the fixture lens since the space within the housing is limited. “Slim” may apply to any of the housings described herein.

The exiting emergency down light fixture is composed emergency battery back and down light fixture. This combination package with emergency battery and light fixture are complicated to wired up and often combining the wrong battery package. This current set up is the lighting fixture and the battery pack are separated, they need to be rewired before completing an installation set up. This installation process is the most painful process. This invention is to alleviate this pain and simplify the installation with simple instruction to save time and save labor. LED ultra slim down light with pre-wired battery and emergency push button indicator. Full metal conduit wiring and combine LED driver and battery backup driver metal housing box.

The exiting emergency down light fixture is a down light with an integrated emergency battery backup and push button indicator, the driver and battery pack in housing preferably constructed of metal, temperature resistant plastic, composite material or any combination thereof.

The exiting emergency down light fixture is more decorative than currently emergency lighting fixtures. This invention have a lighting function and an emergency lighting function in one fixture. Saving additional labor installation and material cost. Takes the guess work out of combining compatible battery pack and LED lighting fixture during installation to set up this type of system.

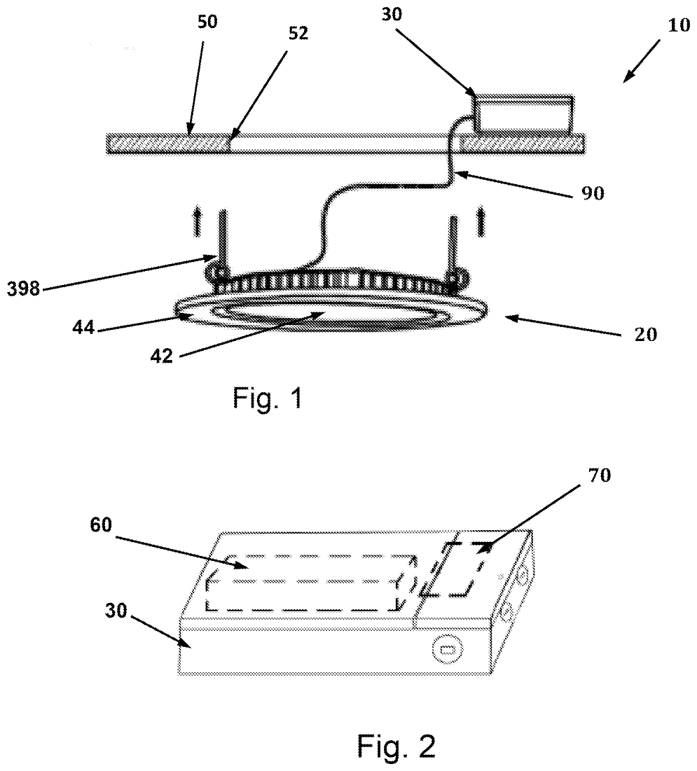

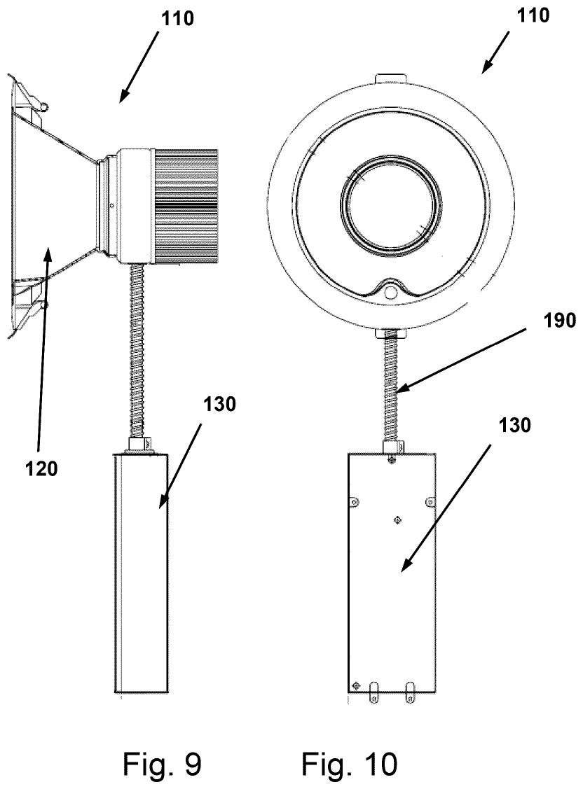

Referring now to the drawings FIGS. 1-12, and more particularly to FIG. 1, there is shown according to the present invention the emergency lighting fixture 10. The emergency lighting fixture 10 includes a control box 30 shown in FIG. 2 and a light housing 20 having reflective surfaces for providing light in a generally downward direction, the light housing 20 mountable to a ceiling surface 50, preferable mounted in an opening 52 of the ceiling. The light housing 20 is particularly useful in ceilings having low clearance in the space above the ceiling. The emergency lighting fixture 10 includes an LED lamp 40 disposed in the light housing 20, the control box 30 movable with respect to the light housing 20, a battery 60 and a control circuit 70 disposed in the control box for controlling power flow through the battery and the power flow through the LED lamp. The battery 60 may alternately be located in the light housing 20. The emergency lighting fixture 10 includes a cable or wire harness 90 electrically connecting the LED lamp 40 through the light housing 20 to the control box 30. The emergency lighting fixture 10 includes at least one LED indicator 84 adjacent or on a lens 42 of the light housing 20, the cable 70 electrically connecting a circuit in the control box 30 and the LED lamp 40 in the light housing 20. The emergency lighting fixture 10 includes a test button 84 disposed on the bottom surface of the light housing 20 or adjacent the lens 42 or outer ring 44. Power is stored in the battery 60 and the battery is in constant electrical connection to the control circuit.

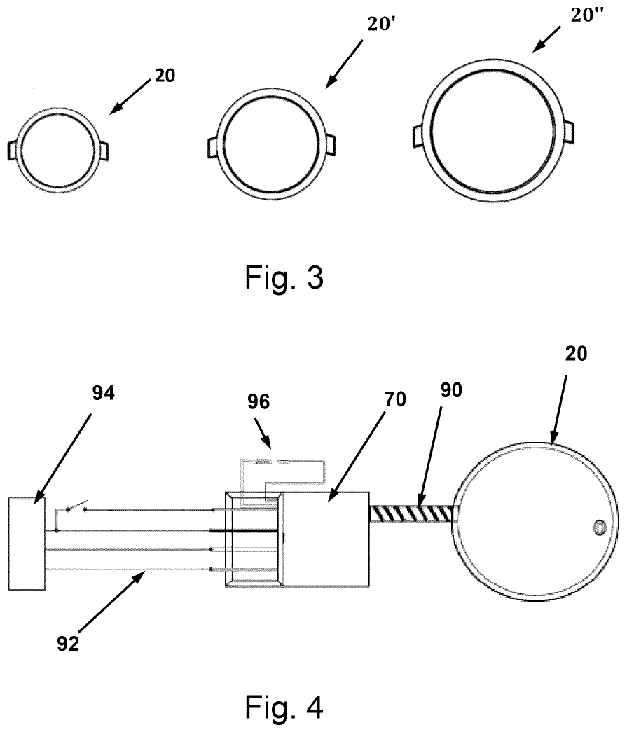

FIG. 3 is a bottom plan view showing various sizes of the light housing of the emergency lighting system. Examples shown are 4″ down light with emergency battery backup 20, 6″ down light with emergency battery backup 20′ and 8″ down light with emergency battery backup 20″. FIG. 4 shows a typical wiring layout for the emergency lighting system;

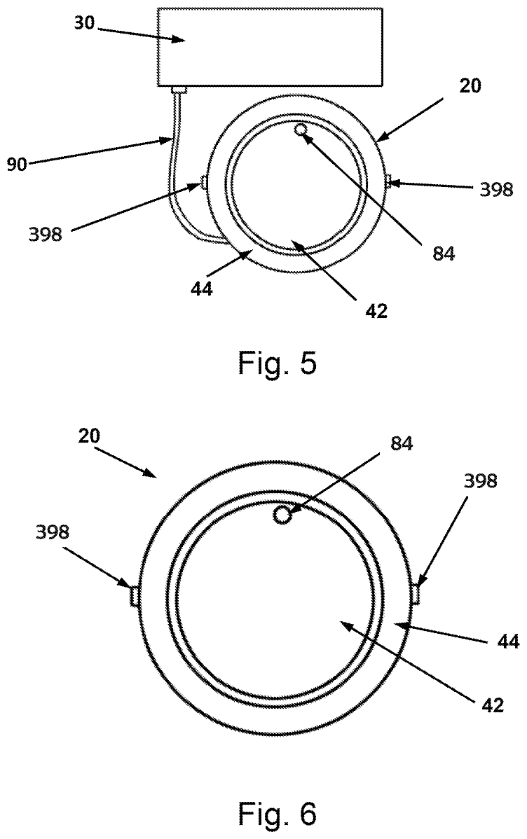

FIG. 5 shows a bottom plan view of the emergency lighting system and FIG. 6 is a bottom plan view of the visible portion of the emergency lighting system. When power is supplied to the LED lamp from the control circuit an area is illuminated below the emergency lighting fixture. The LED indicator may be on when the EBBU mode is activated. If AC power to the EBBU Unit is disconnected or fails for any reason, the LED lamp will continue to operate on battery power and may automatically adjust its output level to an emergency power-saving mode to ensure operation for a specific amount of time.

Once the AC power is restored to the EBBU Unit, the control system will charge and then maintain the emergency battery for best performance. The LED indicator may flicker slowly when the battery in charging and may flicker quickly when an EBBU error occurs. Depressing the test button may activate the EBBU mode while releasing the test button may revert the mode to AC. The emergency lighting fixture may include a dimmer for reducing the power supplied to the LED lamp. The LED lamp may provide at least 1000 lumens. The emergency lighting fixture may be ETL and ES certified. Power into the LED lamp may be between 5 watts and 30 watts and preferably between 10 watts and 18 watts. The LED lamp color may be between 2200K and 6000K and preferably between 2700K and 5000K. The light housing may be constructed of die-cast aluminum. The emergency lighting fixture according to claim 1 wherein the wattage of the LED lamp is tunable. The emergency lighting fixture 10 may include a switch to turn on the LED lamp 40 without initiating the battery backup.

In another aspect of the present invention, FIG. 5 shows a method of installing the emergency lighting fixture. The method includes providing a light housing 20 having reflective surfaces for providing light in a generally downward direction, the housing mountable to a ceiling surface 50 having low clearance, the emergency lighting fixture including an LED lamp 40 disposed in the light housing 20, a control box 30 movable with respect to the light housing 20, a battery 60, a control circuit 70 disposed in the control box 30 for controlling power flow through the battery 60 and the power flow through the LED lamp 40, a wire harness or cable 90 electrically connecting the LED lamp 40 through the light housing 20 to the control box 30, an LED indicator 84 on a bottom surface of the light housing 20 and a test button disposed on the bottom surface of the light housing wherein power is stored in the battery 60 and the battery is in constant electrical connection to the control circuit and wherein when power is supplied to the LED lamp from the control circuit an area is illuminated below the emergency lighting fixture. The method includes providing an opening in a ceiling where the emergency lighting system is to be installed, wiring a power cable to the emergency lighting system control box, placing the control box in above the ceiling and mounting the light housing in the ceiling opening.

The slim LED down light with integrated emergency battery and push button indicator is pre-wired, easier to install and decoratively appealing.

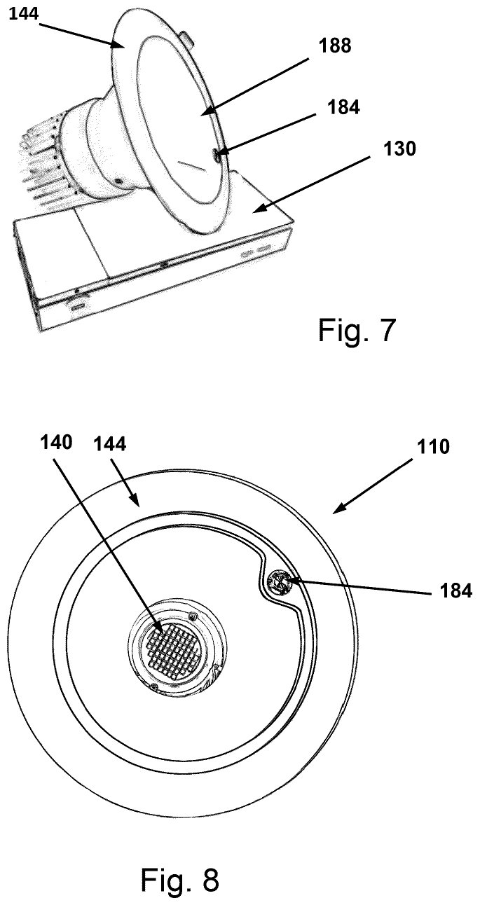

FIGS. 7-10 show a second embodiment of emergency lighting system, the light housing 120 having a higher profile than the light housing 20 described above.

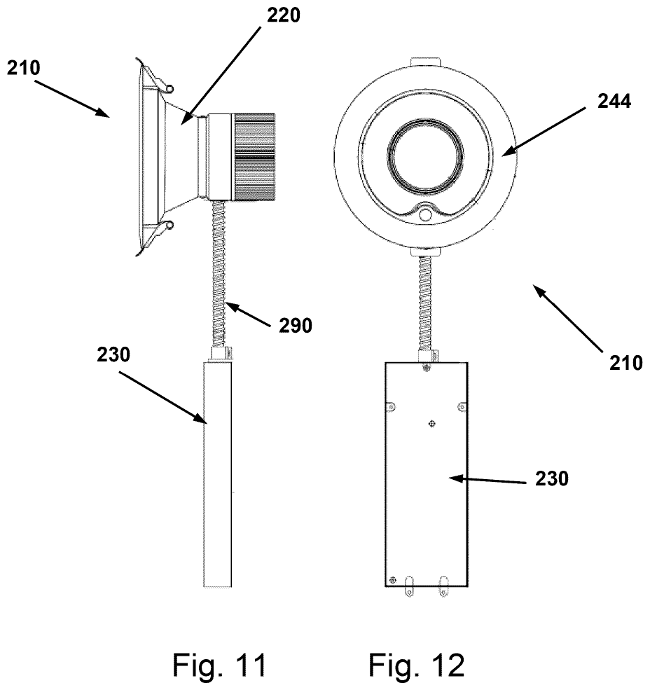

FIG. 11 shows a side elevational view of another embodiment of the emergency lighting system, the light housing 220 having a different light housing than both the light housing 20 and light housing 120. FIG. 12 is a bottom plan view of the emergency lighting system shown in FIG. 11.

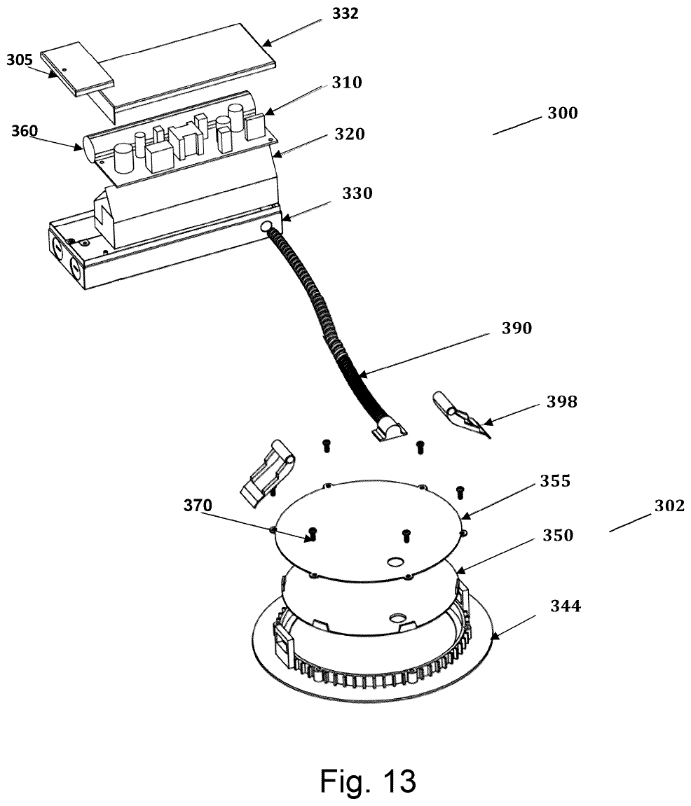

FIG. 13 is a perspective view of yet another embodiment of the emergency lighting system according to the present invention. There is shown, according to the present invention, the emergency lighting fixture 300. The emergency lighting fixture 300 includes a control box 330 and a light housing 302 having reflective surfaces for providing light in a generally downward direction, the light housing 302 mountable to a ceiling surface 50, preferable mounted in an opening 52 of the ceiling. The light housing 302 is particularly useful in ceilings having low clearance in the space above the ceiling. The emergency lighting fixture 300 includes an LED lamp 355 which may be an LED mounted on a circuit board disposed in the light housing 303, the control box 330 movable with respect to the light housing 302, a battery 360 and a control circuit 310 disposed in the control box 330 for controlling power flow through the battery 360 and the power flow through the LED lamp 355. The battery 360 may alternately be located in the light housing 302. The emergency lighting fixture 300 includes a cable or wire harness 390 electrically connecting the LED lamp 355 through the light housing 302 to the control box 330. The emergency lighting fixture 300 includes at least one LED indicator adjacent or on a lens 350 of the light housing 302, the cable 390 electrically connects a circuit 310 in the control box 330 and the LED lamp 355 in the light housing 302. The emergency lighting fixture 300 includes a test button disposed on the bottom surface of the light housing 302 or adjacent the lens 350 or outer ring 344. Power is stored in the battery 360 and the battery 360 is in constant electrical connection to the control circuit 310. The emergency lighting fixture 300 includes a circuit cover 305 for covering the circuit 310 and a control box cover 332 for covering the control box 330. Insulation 320 electrically isolates the control circuit 310 from the control box 330 and control box cover 332. Fasteners 370 secure the LED 355 to the lens 350. Installation fasteners 398 secure the light housing 302 to the opening in the ceiling.

The exiting emergency down light fixture is composed emergency battery back and down light fixture. This invention is to alleviate this pain and simplify the installation with simple instruction to save time and save labor. The present invention is an LED ultra slim down light with pre-wired battery and emergency push button indicator and may include full metal conduit wiring and combine LED driver and battery backup driver metal housing box.

The present invention is a down light with integrated emergency battery backup and push button indicator with combining driver and battery pack in metal housing. The emergency down light is used in commercial building, hospital, school, office and residential housing. This invention is more decorative than currently emergency lighting fixtures. This invention have a lighting function and an emergency lighting function in one fixture. Saving additional labor installation and material cost. The emergency lighting fixture combines compatible battery pack and LED lighting fixture during installation to set up this type of system.

The emergency lighting fixture combines compatible battery pack and down light fixture to create an emergency lighting fixture. The emergency down light includes a pre-wired battery and down light fixture combine in one housing. The housing may be metal or other material such as heat-resistant plastic or composite material. The emergency light fixture may save on labor costs in drilling an additional hole in the ceiling to house the push button by including the push button indicator pre-wired into the fixture which saves on overall installation time.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An emergency lighting fixture comprising:
a light housing having reflective surfaces for providing light in a generally downward direction, the light housing mountable to a ceiling surface having a low clearance above the ceiling surface;
an LED lamp disposed in the light housing;
a control box movable with respect to the light housing;
a battery disposed in the control box;
a control circuit disposed in the control box for controlling power flow through the battery and the power flow through the LED lamp;
a wire harness electrically connecting the LED lamp through the light housing to the control box;
an LED indicator on a bottom surface of the light housing; and
a test button disposed on the bottom surface of the light housing;
wherein depressing the test button turns activates the EBBU mode and releasing the test button reverts the mode to AC;
wherein the LED indicator is on when the EBBU mode is activated;
wherein the LED indicator flickers slowly when the battery in charging;
wherein the LED indicator flickers quickly when an EBBU error occurs;
wherein power is stored in the battery and the battery is in constant electrical connection to the control circuit; and
wherein when power is supplied to the LED lamp from the control circuit an area is illuminated below the emergency lighting fixture.

2. (canceled)

3. (canceled)

4. (canceled)

5. (canceled)

6. The emergency lighting fixture according to claim 1 including a dimmer for reducing the power supplied to the LED lamp.

7. The emergency lighting fixture according to claim 1 wherein the LED lamp provides at least 1000 lumens.

8. The emergency lighting fixture according to claim 1 wherein emergency lighting fixture is ETL and ES certified.

9. The emergency lighting fixture according to claim 1 wherein power into the LED lamp is between 5 watts and 30 watts and preferably between 10 watts and 18 watts.

10. The emergency lighting fixture according to claim 1 wherein LED lamp color is between 2200K and 6000K and preferably between 2700K and 5000K.

11. The emergency lighting fixture according to claim 1 wherein the light housing is constructed of die-cast aluminum.

12. The emergency lighting fixture according to claim 1 wherein the wattage of the LED lamp is tunable.

13. A method for installing an emergency lighting fixture comprising:
providing a light housing having reflective surfaces for providing light in a generally downward direction, the housing mountable to a ceiling surface having low clearance, the emergency lighting system including an LED lamp disposed in the light housing, a control box movable with respect to the light housing, a battery, a control circuit disposed for controlling power flow through the battery and the power flow through the LED lamp, a wire harness electrically connecting the LED lamp through the light housing to the control box, an LED indicator on a bottom surface of the light housing and a test button disposed on the bottom surface of the light housing wherein power is stored in the battery and the battery is in constant electrical connection to the control circuit and wherein when power is supplied to the LED lamp from the control circuit an area is illuminated below the emergency lighting fixture;
wherein depressing the test button turns activates the EBBU mode and releasing the test button reverts the mode to AC;
wherein the LED indicator is on when the EBBU mode is activated;
wherein the LED indicator flickers slowly when the battery in charging;
wherein the LED indicator flickers quickly when an EBBU error occurs;
providing an opening in a ceiling where the emergency lighting system is to be installed;
wiring a power cable to the emergency lighting system control box;
placing the control box in above the ceiling; and
mounting the light housing in the ceiling opening.

14. (canceled)

15. (canceled)

16. (canceled)

17. The method according to claim 13 wherein the LED lamp provides at least 1000 lumens.

18. The method according to claim 13 wherein emergency lighting fixture is ETL and ES certified.

19. The method according to claim 13 wherein power into the LED lamp is between 5 watts and 30 watts and preferably between 10 watts and 18 watts.

20. The method according to claim 13 wherein the light housing is constructed of die-cast aluminum.
